(19) United States
(12) Patent Application Publication
(10) Pub. No.: US 2025/0110943 A1
(43) Pub. Date: Apr. 3, 2025

(54) METHOD AND APPARATUS FOR INTEGRATED OPTIMIZATION-GUIDED INTERPOLATION

(71) Applicant: Ram Pavement, Charlotte, NC (US)

(72) Inventor: Rob Miller, Charlotte, NC (US)

(73) Assignee: Ram Pavement, CHARLOTTE, NC (US)

(21) Appl. No.: 18/375,682

(22) Filed: Oct. 2, 2023

(51) Int. Cl. G06F 16/23; G06N 3/0455

(52) U.S. Cl. CPC G06F 16/2365; G06N 3/0455

(57) ABSTRACT

An apparatus for integrated optimization-guided interpolation in datasets includes at least a processor, and a memory communicatively configuring the at least a processor, the memory containing instructions configuring the at least a processor to receive a first dataset having a known degree of completion, receive a second dataset having an unknown degree of completion, identify at least a missing feature in the second data set, determine that at least a missing feature is a necessary feature, wherein determining further includes determining that the at least a missing feature is a necessary feature according to at least an optimization criterion, interpolate at least an additional datum into the second data set, wherein the at least an additional datum is a substitute for the missing feature, perform a comparative process using the first dataset and the interpolated second dataset, and configure a remote device to display a result of the comparative process.

### FIELD OF THE INVENTION

The present invention generally relates to the field of machine-learning. In particular, the present invention is directed to a method and apparatus for integrated optimization-guided interpolation.

### BACKGROUND

Classification and optimization processes that rely on comparisons of datasets to one another can be difficult where the criteria for comparison involve multiple factors, particularly where the datasets are incomplete. This issue is compounded where information gaps are not necessarily known.

### SUMMARY OF THE DISCLOSURE

In an aspect, an apparatus for integrated optimization-guided interpolation in datasets includes at least a processor, and a memory communicatively configuring the at least a processor, the memory containing instructions configuring the at least a processor to receive a first dataset having a known degree of completion, receive a second dataset having an unknown degree of completion, identify at least a missing feature in the second data set, determine that at least a missing feature is a necessary feature, wherein determining further includes determining that the at least a missing feature is a necessary feature according to at least an optimization criterion, interpolate at least an additional datum into the second data set, wherein the at least an additional datum is a substitute for the missing feature, perform a comparative process using the first dataset and the interpolated second dataset, and configure a remote device to display a result of the comparative process.

In another aspect, a method for integrated optimization-guided interpolation includes receiving, at a processor, a first dataset having a known degree of completion, receiving, at the processor, a second dataset having an unknown degree of completion, identifying, by the processor, at least a missing feature in the second data set, determining, by the processor, that at least a missing feature is a necessary feature, wherein determining further comprises determining that the at least a missing feature is a necessary feature according to at least an optimization criterion, interpolating, by the processor, at least an additional datum into the second data set, wherein the at least an additional datum is a substitute for the missing feature, performing, by the processor, a comparative process using the first dataset and the interpolated second dataset, and configuring, by the processor, a remote device to display a result of the comparative process.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram of an apparatus to automatedly assess and institute a maintenance plan according to an embodiment of the invention;

FIG. 2 is a block diagram of an exemplary machine-learning process;

FIG. 3 is an exemplary embodiment of a chatbot implementation;

FIG. 4 is a diagram of an exemplary embodiment of a neural network;

FIG. 5 is a diagram of an exemplary embodiment of a node of a neural network;

FIG. 6 is an exemplary embodiment of a fuzzy set comparison;

FIG. 7 is a flow diagram illustrating a method of an automated assessment and institution of a maintenance plan; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

Aspects of the present disclosure can improve comparative processes, including machine-learning processes for scoring and/or classification, by identifying significant missing features in datasets to be compared. This may flag processes that could produce erroneous results owing to unquantified or undetected faults or omission in data to be compared. Embodiments disclosed herein further interpolate values to replace missing features to permit valid comparisons; interpolation may be accomplished using generative methods acting on bodies of dataset examples.

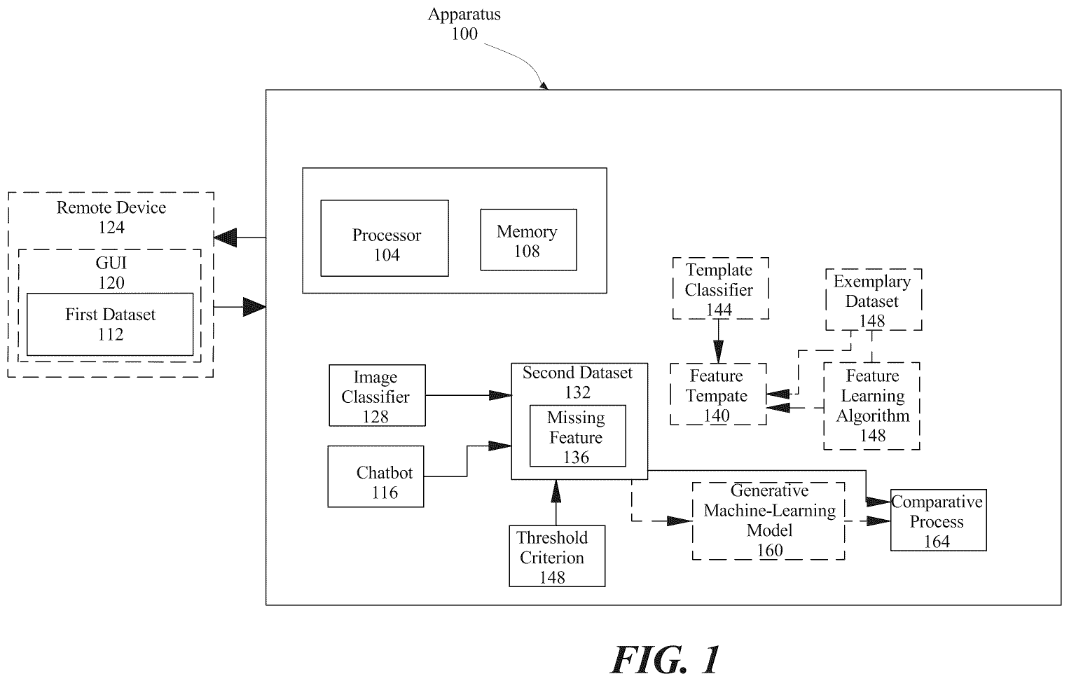

Referring now to FIG. 1, an exemplary embodiment of an apparatus 100 for integrated data synthetization, evaluation, and resource acquisition is illustrated. The apparatus 100 includes a computing device. The computing device includes a processor 104, which is communicatively connected to and configured by a memory 108. As used in this disclosure, “communicatively connected” means connected by way of a connection, attachment or linkage between two or more relata which allows for reception and/or transmittance of information therebetween. For example, and without limitation, this connection may be wired or wireless, direct or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio and microwave data and/or signals, combinations thereof, and the like, among others. A communicative connection may be achieved, for example and without limitation, through wired or wireless electronic, digital or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure.

With continued reference to FIG. 1, apparatus 100 may include any computing device as described in this disclosure, including without limitation a microcontroller, microprocessor, digital signal processor (DSP) and/or system on a chip (SoC) as described in this disclosure. Apparatus 100 may include, be included in, and/or communicate with a mobile device such as a mobile telephone or smartphone. Apparatus 100 may include a single computing device operating independently, or may include two or more computing device operating in concert, in parallel, sequentially or the like; two or more computing devices may be included together in a single computing device or in two or more computing devices. Apparatus 100 may interface or communicate with one or more additional devices as described below in further detail via a network interface device. Network interface device may be utilized for connecting apparatus 100 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Apparatus 100 may include but is not limited to, for example, a computing device or cluster of computing devices in a first location and a second computing device or cluster of computing devices in a second location. Apparatus 100 may include one or more computing devices dedicated to data storage, security, distribution of traffic for load balancing, and the like. Apparatus 100 may distribute one or more computing tasks as described below across a plurality of computing devices of computing device, which may operate in parallel, in series, redundantly, or in any other manner used for distribution of tasks or memory between computing devices. Apparatus 100 may be implemented, as a non-limiting example, using a “shared nothing” architecture.

With continued reference to FIG. 1, processor 104 may be designed and/or configured to perform any method, method step, or sequence of method steps in any embodiment described in this disclosure, in any order and with any degree of repetition. For instance, processor 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Processor 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Still referring to FIG. 1, processor 104 is configured to receive a first dataset 112 having a known degree of completion. As used in this disclosure, a “known degree of completion” exists with regard to first dataset 112 where memory and/or apparatus contains a description of first dataset 112 or of a category of dataset to which first dataset 112 belongs, which may be compared to first dataset 112, and which description indicates either a metric indicating a proportion of potential elements of first dataset 112 that are present therein, and/or a structure having slots or entries for elements of data, to which elements of first dataset 112 may be matched and/or compared to determine whether first dataset 112 an element for each such slot and/or entry, and/or which number or proportion of such slots and/or entries are missing from first dataset 112. As a non-limiting example for the purposes of illustration, where datasets to be compared may relate to construction projects, paving projects, or the like, first dataset 112 may include a comprehensive set of attributes pertaining such projects, such as without limitation a project's timeline, work type, resources, financial data, associated subordinate organizations and their affiliated role(s), resources, personnel, payment status, and the like. As a non-limiting illustration, a first dataset 112 for a driveway pavement project may include a current status of the driveway, a timeline associated with any proposed work, estimated costs of proposed work, personnel and resources allocated to the project, as well as any other accounting, planning, and material data sources, which may include linking additional models. Generally, first dataset 112 may represent a standard, a set of requirements, an idealized dataset, or any other dataset to which a subsequent dataset may be compared, for instance and without limitation for the purposes of evaluating the latter.

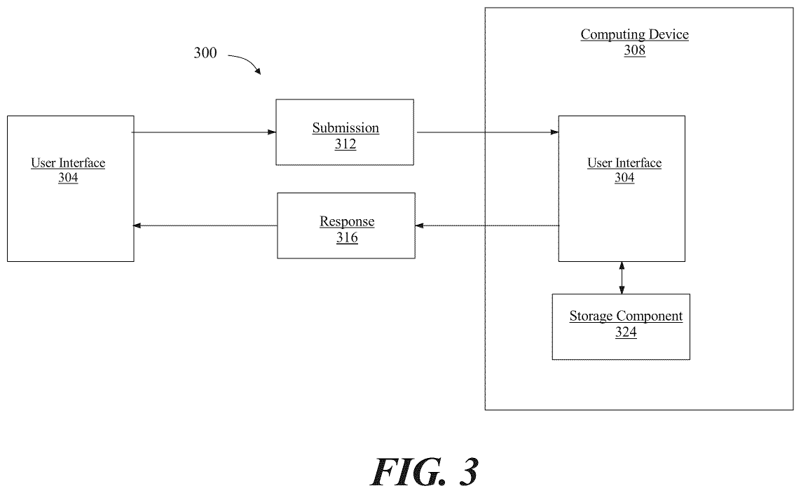

Further referring to FIG. 1, where some or all data in first dataset 112 is entered by a user, processor 104 may further be configured to interface with a user using a chatbot 116 or other interface; processor 104 may be configured to use a decision tree progression to identify missing data for first dataset 112. For instance, and without limitation, where the initial first dataset 112 contains insufficient information to effectively analyze an engagement, processor 104 may be configured to interface with the user using a chatbot 116 or other interface to requests and/or receive additional data. In some embodiments, chatbot 116 interface may be engaged from the outset and enable the complete buildout of the first dataset 112, or any subordinate portion of it. Chatbot 116 operations are discussed in detail below in reference to FIG. 3. User interfaces may be accomplished and/or used to configure a remote device 124, without limitation, as described in further detail below.

Still referring to FIG. 1, processor 104 may be configured to receive a set of standardized parameters through a restricted entry mechanism. As used herein, a “restricted entry mechanism” implies an input which is purposefully limited to a succinct format to simplify the classification and conversion to a machine-readable model. In a non-limiting example, such restricted entries made by the user may initially be confined to multiple choice or binary yes/no entries, then transition to short answers before engaging in image submissions and extended literary entries. As a non-limiting illustration, where a first dataset 112 pertains to a construction project, user may initially be prompted to select from a type of engagement options may describe equipment, construction, landscaping, as well as any other categorization method deemed most effective by the user and/or comparative process 164. Upon identifying a category of engagement, processor 104 may then narrow the queries to the specific information needed to develop an optimal maintenance plan. Continuing the prior non-limiting example, if user selects construction, processor 104 may then prompt for further identification of a specific construction type including options such as roofing, pools, driveways, gutters, or the like. Continuing the above-described non-limiting example, user may select driveway as well as any further specifying prompts presented; one an appropriate category of maintenance type is identified, specific details may be uploaded to develop the more intricate details of a personalized maintenance plan. As used herein, “standardized parameters” refers to a limited set of options in inputting details or answering prompts. In a non-limiting embodiment, standardized parameters for a type of driveway may include concrete, asphalt, gravel, or tamped dirt. In some scenarios, processor 104 may enable subsets of standardized parameters within these initial categories where necessary to ensure an optimally suitable plan.

Still referring to FIG. 1, first dataset 112 may be submitted through a single, mass import by any communicatively connected means. This may be in the form of a thumb drive, CD, DVD, hard drive, or other form of data storage able to be inserted and uploaded in a bulk manner. Alternatively, data may be ingested through the above referenced chatbot 116 which may be integrated into a graphical user interface. A “graphical user interface (GUI 120),” as used herein, is a graphical form of user interface that allows users to interact with electronic devices. In some embodiments, GUI 120 may include icons, menus, other visual indicators, or representations (graphics), audio indicators such as primary notation, and display information and related user controls. A menu may contain a list of choices and may allow users to select one from them. A menu bar may be displayed horizontally across the screen such as pull-down menu. When any option is clicked in this menu, then the pull-down menu may appear. A menu may include a context menu that appears only when the user performs a specific action. An example of this is pressing the right mouse button. When this is done, a menu may appear under the cursor. Files, programs, web pages and the like may be represented using a small picture in a graphical user interface. For example, links to decentralized platforms as described in this disclosure may be incorporated using icons. Using an icon may be a fast way to open documents, run programs etc. because clicking on them yields instant access. Information contained in user interface may be directly influenced using graphical control elements such as widgets. A “widget,” as used herein, is a user control element that allows a user to control and change the appearance of elements in the user interface. In this context a widget may refer to a generic GUI 120 element such as a check box, button, or scroll bar to an instance of that element, or to a customized collection of such elements used for a specific function or application (such as a dialog box for users to customize their computer screen appearances). User interface controls may include software components that a user interacts with through direct manipulation to read or edit information displayed through user interface. Widgets may be used to display lists of related items, navigate the system using links, tabs, and manipulate data using check boxes, radio boxes, and the like. As a further example, user may build an entire first dataset 112 through the use of the chatbot 116. In this type of engagement, chatbot 116 may rely on a decision tree breakdown wherein it may begin by identifying the type of project, then select the most representative stored candidate model to compare and contrast the current user inputs and determine what the next required piece of information is. This comparison method is discussed further below.

Further referring to FIG. 1, GUI 120 may include a plurality of event handlers and/or event handler graphics. As used in this disclosure, an “event handler graphic” is a graphical element with which a user of remote device 124 may interact to enter data, for instance and without limitation for a search query or the like as described in further detail below. An event handler graphic may include, without limitation, a button, a link, a checkbox, a text entry box and/or window, a drop-down list, a slider, or any other event handler graphic that may occur to a person skilled in the art upon reviewing the entirety of this disclosure. An “event handler,” as used in this disclosure, is a module, data structure, function, and/or routine that performs an action on remote device 124 in response to a user interaction with event handler graphic. For instance, and without limitation, an event handler may record data corresponding to user selections of previously populated fields such as drop-down lists and/or text auto-complete and/or default entries, data corresponding to user selections of checkboxes, radio buttons, or the like, potentially along with automatically entered data triggered by such selections, user entry of textual data using a keyboard, touchscreen, speech-to-text program, or the like. Event handler may generate prompts for further information, may compare data to validation rules such as requirements that the data in question be entered within certain numerical ranges, and/or may modify data and/or generate warnings to a user in response to such requirements. Event handler may convert data into expected and/or desired formats, for instance such as date formats, currency entry formats, name formats, or the like. Event handler may transmit data from remote device 124 to apparatus 100.

In an embodiment, and continuing to refer to FIG. 1, event handler may include a cross-session state variable. As used herein, a “cross-session state variable” is a variable recording data entered on remote device 124 during a previous session. Such data may include, for instance, previously entered text, previous selections of one or more elements as described above, or the like. For instance, cross-session state variable data may represent a search a user entered in a past session. Cross-session state variable may be saved using any suitable combination of client-side data storage on remote device 124 and server-side data storage on computing device; for instance, data may be saved wholly or in part as a “cookie” which may include data or an identification of remote device 124 to prompt provision of cross-session state variable by apparatus 100, which may store the data on apparatus 100. Alternatively, or additionally, apparatus 100 may use login credentials, device identifier, and/or device fingerprint data to retrieve cross-session state variable, which apparatus 100 may transmit to remote device 124. Cross-session state variable may include at least a prior session datum. A “prior session datum” may include any element of data that may be stored in a cross-session state variable. Event handler graphic may be further configured to display the at least a prior session datum, for instance and without limitation auto-populating user query data from previous sessions.

Still referring to FIG. 1, processor 104 may be configured to use optical character recognition to interpret handwritten or image data, for instance and without limitation when a user provides some or all of data to be incorporated in first dataset 112 in a scanned or other image-type document with typewritten and/or handwritten letters contained in an image format. For instance, in some embodiments, first dataset 112 may include handwritten, pixelated, or poorly printed documents previously scanned in but not yet recorded as textual data; in such situations, processor 104 may rely on optical character recognition or optical character reader (OCR), executed by processor 104 to automatically convert images of written (e.g., typed, handwritten or printed text) into machine-encoded text, which may then be included in first dataset 112. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

Still referring to FIG. 1, in some cases OCR may be an “offline” process, which analyses a static document or image frame. In some cases, handwriting movement analysis can be used as input to handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

Still referring to FIG. 1, in some cases, OCR processes may employ pre-processing of image component. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform (e.g., homography or affine transform) to image component to align text. In some cases, a de-speckle process may include removing positive and negative spots and/or smoothing edges. In some cases, a binarization process may include converting an image from color or greyscale to black-and-white (i.e., a binary image). Binarization may be performed as a simple way of separating text (or any other desired image component) from a background of image component. In some cases, binarization may be required for example if an employed OCR algorithm only works on binary images. In some cases, a line removal process may include removal of non-glyph or non-character imagery (e.g., boxes and lines). In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms. In some cases, a normalization process may normalize aspect ratio and/or scale of image component.

Still referring to FIG. 1, in some embodiments an OCR process will include an OCR algorithm. Exemplary OCR algorithms include matrix matching process and/or feature extraction processes. Matrix matching may involve comparing an image to a stored glyph on a pixel-by-pixel basis. In some case, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at a same scale as input glyph. Matrix matching may work best with typewritten text.

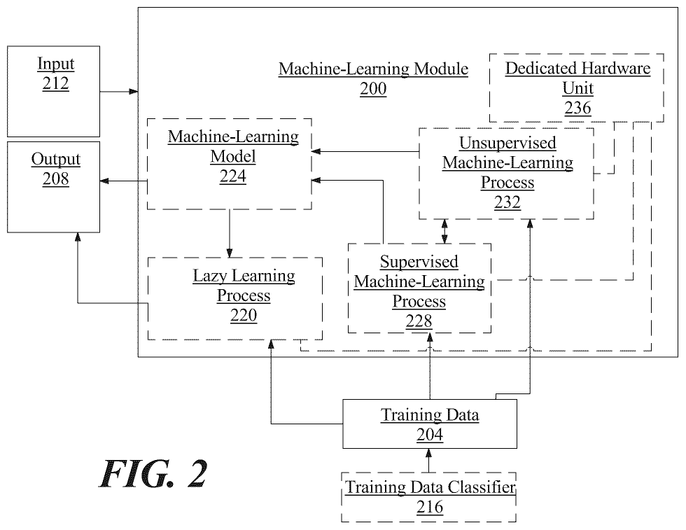

Still referring to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, machine-learning processes like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIG. 2 below. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

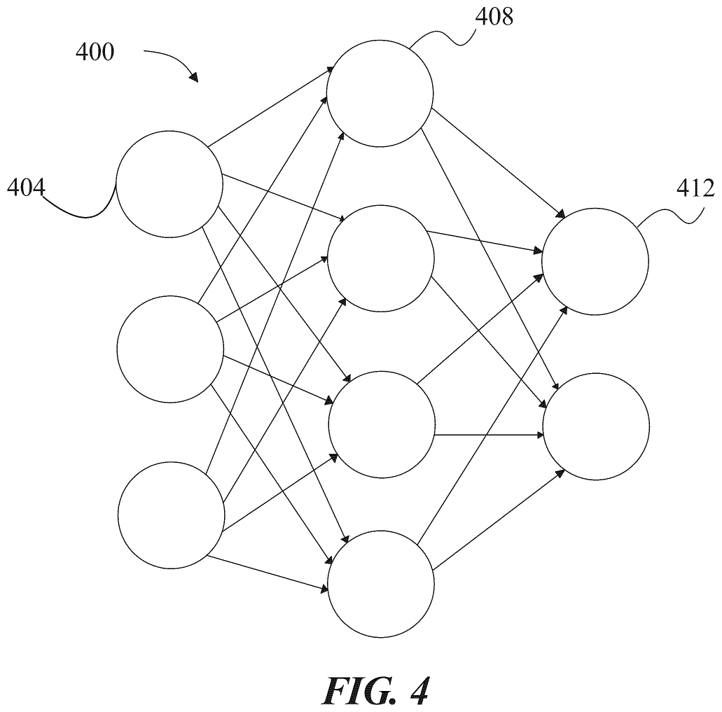

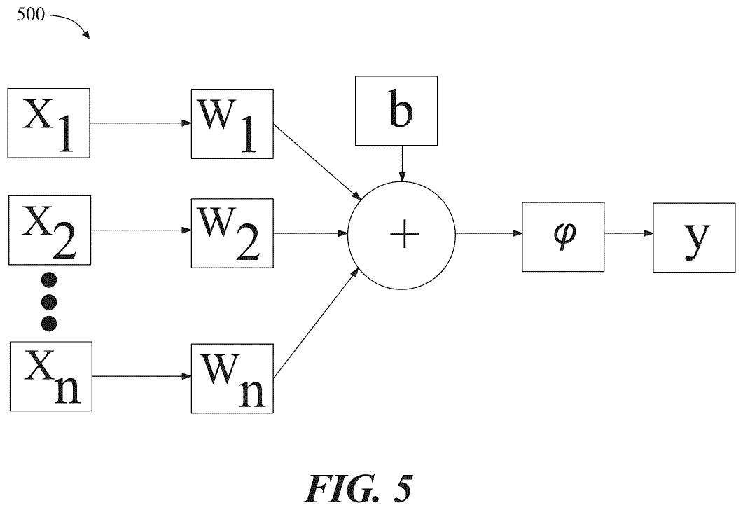

Still referring to FIG. 1, in some cases, OCR may employ a two-pass approach to character recognition. Second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool includes OCRopus. OCRopus development is led by German Research Centre for Artificial Intelligence in Kaiserslautern, Germany. In some cases, OCR software may employ neural networks, for example neural networks as taught in reference to FIGS. 4-5 below.

Still referring to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make us of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

Still referring to FIG. 1, GUI 120 may configure a remote device 124 to display one or more user-interface elements. As used herein, a “remote device 124” is a device communicatively connected to processor 104 and capable of displaying a set of digital information as directed by processor 104; remote device 124 may include any computing device as described in this disclosure. In a non-limiting embodiment, remote device 124 may include a handheld digital device such as a smart mobile phone, a monitor with a wireless, HDMI, or similar connection mechanism, a projector, or any device capable of converting commands from processor 104 to a visible, human-readable context. Remote device 124 may display the GUI 120 as discussed above. Both remote device 124 and GUI 120 displayed information may be modified by the user, machine-learning processes, and/or training data from historical engagements. These modifications may include the information displayed, the color scheme, layout, language used, numeric system used (e.g. metric vs. English units, currency, time zone, etc.), or any other similar variation in the manner of display. Remote device 124 may use any machine-learning processes described in this disclosure to dynamically modify GUI 120 based on training data and user inputs. In a non-limiting embodiment, a pothole repair plan may display the steps over a timeline. But in some circumstances, processor 104 may assess that a single specific portion of the engagement, for example the coordination of the fresh asphalt, is the primary cost/performance driver and that single factor may be prioritized in the display.

Still referring to FIG. 1, processor 104 may be configured to receive at least an image of the project status. Furthermore, processor 104 may be configured to iteratively update first dataset 112 as development progress updated are imported by the user. First dataset 112 may consist of standardized images of the project at an initial assessment phase as well as to provide updates throughout the engagement. In these cases where images are used, machine-learning processes may be used to identify the specific attributes relevant to the various degrees of project maintenance or complexity. In a non-limiting embodiment, a picture of a subject driveway contained within first dataset 112, which was captured from a set lighting, angle, distance, and clarity to allow comparison to a historical database of other subject driveways, may reveal an above-average quantity of cracks or erosion. This historical database of comparable subjects, or candidate sets, may be contained within memory 108. For example, database may be configured as a structured database with contents organized according to a schema or other logical relationships (e.g., relational database). In some embodiments database may be configured as a non-relational database, a semi-structured database, an unstructured database, a key-value store, or the like. Database may be directly coupled to processor 104 or operate in a variety of other possible arrangements. For example, and without limitation, database may be accessed via a network, or the like. Database may be used to store historic data, prior engagements from the entire user base, any model parameters associated with those prior engagements, or any other data which may be relevant and/or applicable in subsequent applications. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database.

Still referring to FIG. 1, image classifier 128 may rely on prior training data executed within machine-learning processes in the form of a subject matter expert inputting pictures then methodically applying classifier descriptors and data tags. Image classifier 128 may also exclusively rely on user feedback from prior engagements. In a non-limiting embodiment, a substantial number of users providing feedback that a given sample driveway image shows evidence of significant weather-induced erosion would enable processor 104 to extrapolate the visible characteristics from those images leading to the classification in a manner that subsequent engagements could reliably diagnose a similar weather-induced erosion condition. In this way, image classifier 128 may rely exclusively on individual user assessments for training data. Additionally, image classifier 128 may accept a bulk import of training data consisting of a multitude of examples of maintenance subjects wherein the relevant conditions are already identified and affiliated. Image classifier 128 may be trained using these examples to establish the same affiliations when similar conditions are presented.

Still referring to FIG. 1, first dataset 112 may be iteratively updated and additively managed. As the project develops and work is conducted, user may upload an exact duplication or similarly executed image capture such that the before and after images may be compared to assess the progress, quality, and remaining work. In a non-limiting embodiment, user may upload a set of images of a driveway crack repair evolution wherein the first images are captured and uploaded prior to any work being executed. User may subsequently upload comparable images after each day of work, or major steps of the evolution, for instance and without limitation as described below for second dataset 132. Images, including those to be compared in processes below, may be conducted from the same lighting, angle, distance, and clarity may enable comparative process 164es to isolate the issue and validate the corrective actions within the user's expectations.

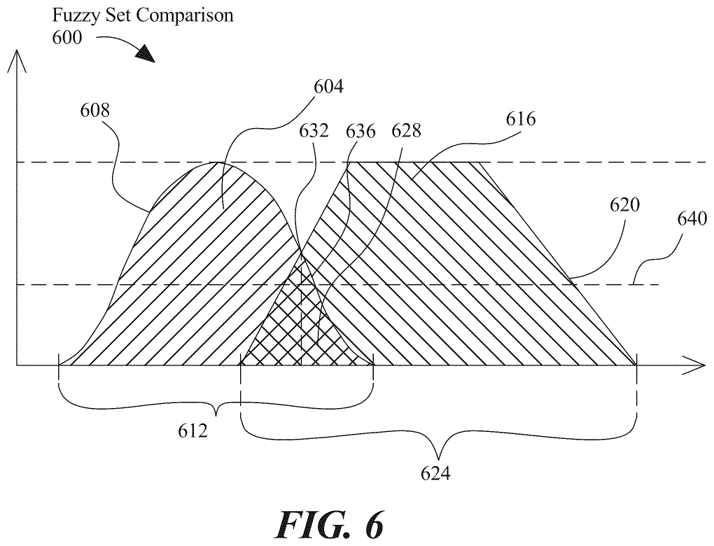

Still referring to FIG. 1, processor 104 may be configured to receive uploaded standard format images to be assessed by a machine-learning algorithm. As used herein, “standard format images” may restrict an uploaded image to a preferred angle, lighting, distance, and clarity based on the type of engagement and further details provided by the user. Requiring this type of standardized image may enable more effective use of training data and machine-learning. Through enforcement of a standardized input, the training data may be more readily applied to congruent engagements and thereby more widely applied to enable faster and more effective refinement of the machine-learning processes. Training data may be provided in the form of user feedback at any individual step, set of steps, or overall process, and may be enabled through a graphical user interface or other mechanism wherein user may accurately assess an input-to-output operation as generally good or bad. A good assessment or its equivalent may be used to promote the specified affiliation in subsequent operations, while a bad assessment or its equivalent may be used to suppress the specified affiliation in subsequent operations. Image classifier 128 may append a set of classifier descriptors summarizing the contents of the submitted standard format images. As used herein, a “classifier descriptor” is a type of data tag which is digitally attached to a picture, engagement, or user profile. This data tag is subsequently used by processor 104 to execute the requisite analysis and generation functions and build an engagement-specific maintenance plan. In a non-limiting embodiment, a first dataset 112 may have classifier descriptors of “driveway”, “asphalt”, “20-year original age”, “crumbling deterioration”, “lifetime cost prioritization”, etc. Additionally, a subsequently uploaded image after some portion of work is done may contain the same set of descriptors, but machine-learning processes may modify the “crumbling deterioration” descriptor to reflect the corrective action and apply a descriptor of “recent crack patched,” “recent repairs,” minor deterioration,” or any similarly useful data. Application of classifier descriptors may be based on matching algorithms wherein a given attribute or set of attributes within first dataset 112 is converted to a representative vector, which may then use a fuzzy set analysis to compare the attribute or set of attributes with a classifier descriptor or set of classifier descriptors. Fuzzy set pairing is discussed in detail below in reference to FIG. 6.

Continuing to refer to FIG. 1, classifier descriptors may be used to capture specific details within an image, enable analysis and processing, and improve accuracy of comparisons as described in further detail below. Training data and development of machine-learning processes is described in detail below in reference to FIG. 2. Use of classifier descriptors is also described in detail within Non-provisional Application No. [1531-001USU1] filed on Oct. 2, 2023 and entitled “A METHOD AND APPARATUS FOR AUTOMATED ANALYSIS AND IMPLEMENTATION OF A SUSTAINMENT PROGRAM,” the entirety of which is incorporated herein by reference

Still referring to FIG. 1, a profile classifier 132 may convert elements of first dataset 112 and/or other datasets described herein standardized equivalents, and/or may embed as additional data and/or metadata one or more standardized equivalents and/or descriptors of elements of first dataset 112, to more effectively conduct the subsequent processing and evaluation. Profile classifier 132 may operate similarly to image classifier 128, in that it applies a plurality of classifier descriptors to individual pieces of data, groupings of information, and/or the overall first dataset 112 and/or other datasets described herein. In a non-limiting embodiment, a first dataset 112 may address a single family household roof, wherein the user has identified all of the physical attributes separately. Profile classifier 132, continuing in the non-limiting embodiment, may apply classifier descriptors consisting of “roof”, “single household”, “60-degree”, “high complexity”, “multi-gable”, “priority-lifecycle cost”, “double-layered, asphalt shingle”, “minor deterioration”, “high heat and sunlight exposure”, as well as any other set of conditions able to be captured within first dataset 112 and/or other datasets described herein and relevant to the generation of a maintenance plan. Both image classifier 128 and profile classifier 132 may rely on fuzzy set comparison to identify the appropriate classifier descriptor uses. In a non-limiting embodiment, machine-learning processes may apply vector representations of each descriptor and to each individual part of a first dataset 112 and/or other datasets described herein, wherein the vector representations consisting of both a scalar quantity and a directional characteristic may then be compared against a set threshold to assess the appropriate application of classifier descriptors. Fuzzy set comparisons are discussed in detail below in reference to FIG. 6.

Still referring to FIG. 1, processor 104 is configured to receive a second dataset 132 having an unknown degree of completion. As used in this disclosure, an “unknown degree of completion” for a data structure indicates that it is not clear how much information is missing from the data structure, and/or how much information would be needed to achieve a desired or specified degree of completion. For instance, with regard to a data structure describing a phenomenon, such a data structure may have an unknown degree of completion where, at least initially, it is not known how much additional data is necessary to accurately describe the phenomenon that the dataset represents and/or to perform comparison processes as described in further detail below. As a non-limiting example, where second dataset 132 includes evidence or information regarding completion of a construction and/or paving project, it may not be apparent from second dataset 132 whether it contains sufficient information to ascertain completion of the construction and/or paving project.

With continued reference to FIG. 1, receiving second dataset 132 may include receiving at least an image. At least an image may include without limitation, photographs, including digital photographs and/or scanned printed photographs. At least an image may include, for instance, an image of a construction and/or paving project that has ostensibly been partially or wholly completed. Receiving second dataset 132 may include converting at least an image into one or more elements of textual data, and/or generating one or more elements of textual data using at least an image. In some embodiments, this may be performed by identifying and/or parsing metadata provided with the at least an image. In some embodiments, generating second dataset 132 may include generating the second dataset 132 using at least an image and an image classifier 128. Image classifier 128 may include any classifier as described in this disclosure, may be trained using any classification algorithm described in this disclosure and training data, and/or may be utilized in any manner described in this disclosure. Training data for image classifier 128 may include a plurality of images combined with one or more correlated textual descriptions thereof; such training examples may be produced by user entries associating images with descriptions, or in any other manner that may occur to persons skilled in the art upon reading the entirety of this disclosure. Thus, image classifier 128 may receive images and output textual descriptions matching such images, which textual descriptions may be added to second dataset 132. In some embodiments, generating second dataset 132 may include generating the second dataset 132 using the at least an image and an optical character recognition process. For instance, OCR may be used as described above to extract textual data from images containing textual elements. Data for second dataset 132 may alternatively or additionally be entered verbally and/or textually by one or more users, uploaded and/or scanned in as one or more documents, received in the form of electronic messages, or the like. Processor 104 may be configured to at least initially, and periodically thereafter, import data from at least an affiliated database. The second dataset 132 may be sourced from real-time, live models of information, wherein the data stops being automatedly updated once it is ingested by processor 104. For this reason, processor 104 may enable and require periodic updates to ensure processing and outputs are based on the most up-to-date, reliable information available. The appropriate periodicity of ingesting updated second dataset 132 may be based solely upon whenever the user decides to import the update. Processor 104 may also be configured to recommend importing an updated set of second dataset 132 when it recognizes that certain types of data changed often and caused significant variations in the processing and outputs of processor 104.

Still referring to FIG. 1, processor 104 may be configured to compile categories of data of second dataset 132 pertaining to common tasks, artifacts, personnel, and timing. Data synthesis module 136 may allow for user-specified organization and display methods. Where selected by the user, either through the chatbot 116 engagement, GUI 120 selection, manual entry, or set by machine-learning processes based on historic engagements, data synthesis 136 may apply the organization method to the classified data. In a non-limiting embodiment, user may submit a disaggregated, bulk import wherein the data comprises a new parking lot construction. Continuing in this embodiment, processor 104 may apply an organization method by time-bracketing the engagement within milestone events such as initial property assessment, preparatory leveling and tamping of the area, curb installation, asphalt pour and flattening, and completion. In this case, the organization based on the milestone events may be applied manually by the user or rely on training data which may be sourced from proprietary methods used or from successful historical engagements. Similarly, data synthesis 136 may be organized by cost drivers wherein the largest expenditures are grouped together with a tiered decrementing method for the remaining expenditures. Alternatively, data synthesis may implement a personnel-based organization method, wherein each employee is shown by the work they will be affiliated with along with their individual costs and timelines. These examples are non-exhaustive and additional similar methods may be employed within processor 104 as determined by the user. Data synthesis 136 may additionally identify discrepancies within the affiliated models. In another non-limiting embodiment, data synthesis 136 may identify an employee allocated to an engagement, but that employee has not logged any hours toward the engagement. In each case where data synthesis 136 identifies a piece of data that is not aligned with expectations based on first dataset 112, for instance and without limitation during a comparative process 164 as described below, it may display the data for the user through remote device 124 and/or GUI 120. This display may be in the form of a logged error which user may query at any time, or it may be displayed independently or as part of a list of data which user should evaluate for correctness, or it may generate a dialogue window requiring immediate acknowledgement of the discrepancy, all depending on the severity and user preferences.

Continuing to refer to FIG. 1, processor 104 and/or apparatus may be configured to identify at least a missing feature 136 in the second data set. A “feature,” as used in this disclosure, is an element of data to be input to a comparative process 164 as described below. A missing feature 136 is a feature that can be input to a comparative process 164 to be used in a given embodiment, but which is not present in second dataset 132.

With further reference to FIG. 1, identifying at least a missing feature 136 may include classifying the second dataset 132 to a feature template 140 using a template classifier 144. A “feature template 140,” as used in this disclosure, is a data structure that lists features to be used in a comparative process 164; in an embodiment, identification of a feature template 140 may be equivalent to and/or substituted by identification of a comparative process 164. In some embodiments, feature template 140 and/or comparative process 164 may already be associated in data stored in apparatus with second dataset 132; for instance, a user may have entered such association as a user instruction. In some embodiments classification to a feature template 140 may be performed using template classifier 144. Template classifier 144 may be trained using training data associating datasets with correlated templates; such training examples may be produced by user entries associating datasets with templates, or in any other manner that may occur to persons skilled in the art upon reading the entirety of this disclosure. Template classifier 144 may be trained using any classification algorithm described herein. Alternatively or additionally, first dataset 112 and/or other data stored and/or provided by users, may identify a feature template 140 to be used in evaluating second dataset 132. In a non-limiting example, identifying at least a missing feature 136 may include comparing the second dataset 132 to a feature template 140, such as a feature template 140 identified using a template classifier 144, and identifying at least a missing feature 136 based on the comparison. Comparison may include, without limitation, element-by-element comparison, arrangement of elements into vectors and geometric comparison of vectors using cosine similarity or other metrics, or any other form of comparison that may occur to persons skilled in the art upon reviewing the entirety of this disclosure.

Alternatively or additionally, and still referring to FIG. 1, identifying at least a missing feature 136 may include receiving at least an exemplary dataset 148 and training a feature identification machine-learning model as a function of the at least an exemplary dataset 148. An “exemplary dataset 148” as used in this disclosure, is an example of a dataset suitable for use as second dataset 132, such as a dataset used in a previous iteration of a method as described herein, a dataset generated as an ideal or other example by user inputs, a dataset describing a phenomenon of a type to be described by second dataset 132, or the like. At least an exemplary dataset 148 may include a plurality of exemplary datasets 148. Feature identification machine-learning model may be generated, without limitation, using a feature learning algorithm 152. A “feature learning algorithm 152,” as used herein, is a machine-learning algorithm that identifies associations between elements of data in a data set, which may include without limitation a training data set, where particular outputs and/or inputs are not specified. For instance, and without limitation, a feature learning algorithm 152 may detect co-occurrences datasets suitable for use as second dataset 132, and/or elements thereof. Apparatus 100 may perform a feature learning algorithm 152 by dividing datasets into various sub-combinations of such data to evaluate which subcombinations tend to co-occur with which other subcombinations. In an embodiment, first feature learning algorithm 152 may perform clustering of data.

Continuing refer to FIG. 1, a feature learning and/or clustering algorithm may be implemented, as a non-limiting example, using a k-means clustering algorithm. A “k-means clustering algorithm” as used in this disclosure, includes cluster analysis that partitions n observations or unclassified cluster data entries into k clusters in which each observation or unclassified cluster data entry belongs to the cluster with the nearest mean, using, for instance exemplary datasets 148 as described above. “Cluster analysis” as used in this disclosure, includes grouping a set of observations or data entries in way that observations or data entries in the same group or cluster are more similar to each other than to those in other groups or clusters. Cluster analysis may be performed by various cluster models that include connectivity models such as hierarchical clustering, centroid models such as k-means, distribution models such as multivariate normal distribution, density models such as density-based spatial clustering of applications with nose (DBSCAN) and ordering points to identify the clustering structure (OPTICS), subspace models such as biclustering, group models, graph-based models such as a clique, signed graph models, neural models, and the like. Cluster analysis may include hard clustering whereby each observation or unclassified cluster data entry belongs to a cluster or not. Cluster analysis may include soft clustering or fuzzy clustering whereby each observation or unclassified cluster data entry belongs to each cluster to a certain degree such as for example a likelihood of belonging to a cluster; for instance, and without limitation, a fuzzy clustering algorithm may be used to identify clustering of gene combinations with multiple disease states, and vice versa. Cluster analysis may include strict partitioning clustering whereby each observation or unclassified cluster data entry belongs to exactly one cluster. Cluster analysis may include strict partitioning clustering with outliers whereby observations or unclassified cluster data entries may belong to no cluster and may be considered outliers. Cluster analysis may include overlapping clustering whereby observations or unclassified cluster data entries may belong to more than one cluster. Cluster analysis may include hierarchical clustering whereby observations or unclassified cluster data entries that belong to a child cluster also belong to a parent cluster.

With continued reference to FIG. 1, computing device may generate a k-means clustering algorithm receiving unclassified physiological state data and outputs a definite number of classified data entry clusters wherein the data entry clusters each contain cluster data entries. K-means algorithm may select a specific number of groups or clusters to output, identified by a variable “k.” Generating a k-means clustering algorithm includes assigning inputs containing unclassified data to a “k-group” or “k-cluster” based on feature similarity. Centroids of k-groups or k-clusters may be utilized to generate classified data entry cluster. K-means clustering algorithm may select and/or be provided “k” variable by calculating k-means clustering algorithm for a range of k values and comparing results. K-means clustering algorithm may compare results across different values of k as the mean distance between cluster data entries and cluster centroid. K-means clustering algorithm may calculate mean distance to a centroid as a function of k value, and the location of where the rate of decrease starts to sharply shift, this may be utilized to select a k value. Centroids of k-groups or k-cluster include a collection of feature values which are utilized to classify data entry clusters containing cluster data entries. K-means clustering algorithm may act to identify clusters of closely related data, which may be provided labels; this may, for instance, generate an initial set cluster labels from an initial set datasets, and may also, upon subsequent iterations, identify new clusters to be provided new labels, to which additional data may be classified, or to which previously data may be reclassified.

With continued reference to FIG. 1, generating a k-means clustering algorithm may include generating initial estimates for k centroids which may be randomly generated or randomly selected from unclassified data input. K centroids may be utilized to define one or more clusters. K-means clustering algorithm may assign unclassified data to one or more k-centroids based on the squared Euclidean distance by first performing a data assigned step of unclassified data. K-means clustering algorithm may assign unclassified data to its nearest centroid based on the collection of centroids cᵢ of centroids in set C. Unclassified data may be assigned to a cluster based on argmin_{∃C}dist (cᵢ,x)², where argmin includes argument of the minimum, ci includes a collection of centroids in a set (′, and dist includes standard Euclidean distance. K-means clustering module may then recompute centroids by taking mean of all cluster data entries assigned to a centroid's cluster. This may be calculated based on ci=1/|Si|Σxi∃Si^{xi}. K-means clustering algorithm may continue to repeat these calculations until a stopping criterion has been satisfied such as when cluster data entries do not change clusters, the sum of the distances have been minimized, and/or some maximum number of iterations has been reached.

Still referring to FIG. 1, k-means clustering algorithm may be configured to calculate a degree of similarity index value. A “degree of similarity index value” as used in this disclosure, includes a distance measurement indicating a measurement between each data entry cluster generated by k-means clustering algorithm and a selected physiological data set. Degree of similarity index value may indicate how close a particular dataset is to being classified by k-means algorithm to a particular cluster. K-means clustering algorithm may evaluate the distances of the dataset to the k-number of clusters output by k-means clustering algorithm. Short distances between a set of data and a cluster may indicate a higher degree of similarity between the set of data and a particular cluster. Longer distances between a set of data and a cluster may indicate a lower degree of similarity between a data set and a particular cluster.

With continued reference to FIG. 1, k-means clustering algorithm selects a classified cluster as a function of the degree of similarity index value. In an embodiment, k-means clustering algorithm may select a classified cluster with the smallest degree of similarity index value indicating a high degree of similarity between a data set and the cluster. Alternatively or additionally k-means clustering algorithm may select a plurality of clusters having low degree of similarity index values to physiological data sets, indicative of greater degrees of similarity. Degree of similarity index values may be compared to a threshold number indicating a minimal degree of relatedness suitable for inclusion of a set of physiological data in a cluster, where degree of similarity indices a-n falling under the threshold number may be included as indicative of high degrees of relatedness. The above-described illustration of feature learning using k-means clustering is included for illustrative purposes only and should not be construed as limiting potential implementation of feature learning algorithms 152; persons skilled in the art, upon reviewing the entirety of this disclosure, will be aware of various additional or alternative feature learning approaches that may be used consistently with this disclosure.

With further reference to FIG. 1, identifying at least a missing feature 136 may include identifying the at least a missing feature 136 using the feature identification machine-learning model and the second dataset 132. For instance, and without limitation, second dataset 132 may converted into a data structure, such as a vector or the like, which can be compared to clusters, cluster centroids, or the like in a k-means clustering algorithm as described above. In an embodiment, processor 104 and/or apparatus 100 may be configured to classify and/or match second dataset 132 and/or a data structure converted therefrom to one or more clusters and/or cluster centroids. A data structure relating to and/or representing a cluster centroid may be used as a feature template 140 as described above. Thus, for instance, where second dataset 132 lacks features associated with and/or included in a cluster centroid, elements that cluster close to a cluster centroid, and/or a feature template 140 associated therewith, such features may be identified as missing features 136.

Still referring to FIG. 1, and as a non-limiting example processor 104 may be configured to compare the received second dataset 132 to a requirement list and/or other feature template 140 and/or data structure identified using a clustering algorithm to determine gaps. To thoroughly compare the data, processor 104 may first ingest data from any affiliated models. This may be accomplished as described above through user manual imports. Ingesting data from any affiliated models may also be automated through a syncing mechanism wherein any updates to any affiliated models are automatically delivered to processor 104. Processor 104 may then corroborate redundant data between the models. Where the data is equitable, no action may be taken. Where the affiliated models disagree or do not align, processor 104 may identify the most commonly occurring data and select that as correct. Processor 104 may additionally prompt the user to select the most likely correct information through GUI 120. Processor 104 may additionally rely on machine-learning processes to identify common mistakes in the data and suppress any data based on mistaken sources. Training data for this type of analysis may come from user feedback in prior engagements. In a non-limiting embodiment, where user selects a correct entry and identifies a separate entry as wrong, processor 104 may use this identification, as well as any adjacent data characteristics to learn the reasoning and automatically propose subsequent selections based on the training data. Once all data is compiled and aligned, processor 104 may compare the status, resources, cost, and timing against a candidate model, as described above. The candidate model may have an affiliated list of resources, costs, and timing for each of the primary tasks associated with it. Processor 104 may compare the received first dataset 112 to this candidate model and compile a list of potential gaps to be assessed and mitigated as discussed below.

Still referring to FIG. 1, processor 104 may be configured to use machine-learning processes to conduct next-layer analysis. As used herein, “next-layer analysis” consists of identifying any missing or questionable information which may not be aligned to the traditional plan, as assessed by machine-learning processes and historical training data. In a specific non-limiting embodiment, a next-layer analysis may consist of evaluating the prior example of a new parking lot construction and recognize that the only drum roller will be employed in a separate engagement and a time-sharing agreement may be necessary. In these types of obvious, but often overlooked equipment conflicts, data synthesis 136 may generate a prompt to the user through remote device 124 and/or GUI 120. In a separate, non-limiting embodiment, data synthesis 136 may identify an accounting error wherein a rental cost was improperly extrapolated with an additional decimal point causing the resulting project cost estimation to be erred by an order of magnitude. Next-layer analyses may depend upon historical user feedback of identified errors as training data to support subsequent identification of the same or similar errors.

With continued reference to FIG. 1, processor 104 and/or apparatus 100 is configured to determine that at least a missing feature 136 is a necessary feature, as used herein, a “necessary feature” is a feature which, if excluded from second dataset 132, causes a comparative process 164 to fail to produce valid results, such as results that are correct according to a measure of accuracy, convergence, confidence interval, or the like. In an embodiment, determining that the at least a missing feature 136 is a necessary feature includes determining that the at least a missing feature 136 is a necessary feature according to at least an optimization criterion. An “optimization criterion,” as used in this disclosure, is a criterion according to which a comparative process 164 as described below may be determined to be valid as described above. Validity may be measured according to a user-select and/or default optimization criterion and/or value.

Still referring to FIG. 1, in some embodiments at least an optimization criterion is or includes a threshold criterion 156. A “threshold criterion 156,” as used in this disclosure, is one or more numerical parameters and/or constraints to which metrics relating to missing feature 136 and/or second dataset 132 may be compared to determine whether at least a missing feature 136 is and/or includes a necessary feature. In some embodiments, determining that at least a missing feature 136 is a necessary feature may include generating an importance metric using the identification of the at least a missing feature 136, comparing the importance metric to the threshold criterion 156, and determining that at least a missing feature 136 is a necessary feature as a function of the comparison. An “importance metric,” as used in this disclosure, is one or more numerical parameters and/or metrics generated using at least a missing feature 136 and/or second dataset 132 which may be compared to a threshold criterion 156 to determine whether at least a missing feature 136 is and/or includes a necessary feature.

In some embodiments, and further referring to FIG. 1, generating importance metric may include receiving a plurality of training examples, wherein each training example correlates an identification of a feature with an importance metric parameter, training an importance metric machine-learning model as a function of the plurality of training examples, and generating the importance metric using the identification of the at least a missing feature 136 and the importance metric machine-learning model. Training data may be received and/or generated in any manner as described herein, including without limitation by assigning scores to past examples of datasets, where scores may measure how accurate comparative process 164es using such past examples were discovered to be, may reflect ratings by one or more users of outcomes of processes and/or phenomena being assessed and/or measured using comparative process 164 and/or represented by example datasets, may include metrics generated during comparative process 164es as described in further detail below, or the like.

Still referring to FIG. 1, in some embodiments generating importance metric may include performing a comparative process 164 as below and generating an importance metric using the comparative process 164. For instance, generating importance metric may include, identifying a degree or amount of convergence, a percentage convergence, or the like as produced by a comparative process 164, where “convergence” indicates a degree to which a comparative process 164 may have arrived at a solution; convergence may, for instance, be measured multiple times using Monte Carlo simulation and averaged or otherwise aggregated. Generation of importance metric may include mapping a convergence to a degree of accuracy of comparison process. This may in turn be compared to a threshold criterion 156 as described above.

Further referring to FIG. 1, comparison of importance metric to threshold criterion 156 may include a comparison of one or more numbers to another; for instance, in some embodiments an importance metric exceeding threshold criterion 156 may indicate that at least a missing feature 136 is necessary. As a further non-limiting example, importance metric less than and/or less than or equal to threshold criterion 156 may indicate missing feature 136 is important. Alternatively or additionally, each of threshold criterion 156 and importance metric may be represented using one or more fuzzy sets, and comparison may include comparison using a fuzzy inferencing system. For instance, and without limitation, a first criterion (or in other embodiments, a sole criterion) for importance may include a number or percentage of data missing as a result of missing features 136, such as a percentage or number of features expected according to a feature template 140 as described above, which may be mapped to fuzzy sets representing “substantially complete” for completion percentage ranging from 80 percent to above, “mostly complete” for ranging from 70 percent to 90 percent, “mostly incomplete” for a percentage ranging from 60 percent to 80 percent, and “incomplete” for a percentage ranging from 50 percent to 70 percent. Similarly, a measurement for degree of convergence may be mapped to overlapping fuzzy sets representing “highly convergent,” “moderately convergent,” and “insufficiently convergent” or the like. Continuing the above-described example, a set of fuzzy inferencing rules may require that either is in the top-level fuzzy set while neither is at the lowest fuzzy set or that both are at least at the second-highest fuzzy set, for the at least a missing feature 136 to be unnecessary; persons skilled in the art, upon reviewing the entirety of this disclosure, will be aware of various alternative or additional ways in which linguistic variables may represent importance metrics and/or in which fuzzy inferencing systems may implement threshold criteria. Any or all parameters of fuzzy sets described above may be tuned using training examples wherein users label values as belonging to some degree to one or more fuzzy sets, by iteratively modifying parameters to minimize error between user labels and set membership.

With continued reference to FIG. 1, processor 104 and/or apparatus is configured to interpolate at least an additional datum into the second data set, wherein the at least an additional datum is a substitute for the missing feature 136. “Interpolation,” as used in this disclosure, means generation and/or addition of additional data where a gap such as a missing feature 136 exists, based on existing data. In some embodiments, interpolation may include generating user inquiries and/or interacting with users as described above using GUIs 120, chatbots 116, or the like. Alternatively or additionally, interpolating at least an additional datum may include receiving at least an exemplary dataset 148 and interpolating at least an additional datum as a function of the at least an exemplary dataset 148. An “exemplary dataset 148,” as used herein, is a dataset representing a similar phenomenon to that represented by second dataset 132; for instance, where second dataset 132 represents data concerning a paving or construction project, an exemplary dataset 148 may represent one or more other paving or construction projects of a similar type, scope, or the like. At least an exemplary dataset 148 may have no missing features 136 and/or may have no necessary missing features 136 as described above.

Still referring to FIG. 1, processor 104 and/or apparatus 100 may be configured to interpolate the at least an additional datum by training a generative machine-learning model using the at least an exemplary dataset 148 and a generative machine-learning algorithm and interpolating at least an additional datum using the generative machine-learning model.

With continued reference to FIG. 1, in one or more embodiments, interpolation may be performed using one or more aspects of “generative artificial intelligence (AI),” a type of AI that uses machine learning algorithms to create, establish, or otherwise generate data such as, without limitation, missing features 136 and/or the like in any data structure as described herein (e.g., text, image, video, audio, among others) that is similar to one or more provided training examples. In an embodiment, machine learning module described herein may generate one or more generative machine learning models 160 that are trained on one or more set of exemplary datasets 148, where exemplary datasets 148 may have labels according to feature templates 140 indicating which elements of exemplary datasets 148 correspond to which features. One or more generative machine learning models 160 may be configured to generate new examples that are similar to the training data of the one or more generative machine learning models 160 but are not exact replicas; for instance, and without limitation, data quality or attributes of the generated examples may bear a resemblance to the training data provided to one or more generative machine learning models 160, wherein the resemblance may pertain to underlying patterns, features, or structures found within the provided training data. Thus, in a non-limiting example, generative machine learning model 160 may generate features to be used for missing features 136 and/or necessary missing features 136 as described above.

Still referring to FIG. 1, in some cases, generative machine learning models 160 may include one or more generative models. As described herein, “generative models” refers to statistical models of the joint probability distribution P(X, Y) on a given observable variable x, representing features or data that can be directly measured or observed (e.g., features that are not missing from second dataset 132) and target variable y, representing the outcomes or labels that one or more generative models aims to predict or generate (e.g., values to be added for missing features 136 in second dataset 132). In some cases, generative models may rely on Bayes theorem to find joint probability; for instance, and without limitation, Naïve Bayes classifiers may be employed by computing device, processor 104 and/or apparatus 100 to categorize input data such as, without limitation, elements of exemplary feature datasets and/or elements of second dataset 132 into different labels of features, clusters, or the like such as.

In a non-limiting example, and still referring to FIG. 1, one or more generative machine learning models 160 may include one or more Naïve Bayes classifiers generated, by computing device, using a Naïve bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A) P(A)÷P(B), where P (A/B) is the probability of hypothesis A given data B also known as posterior probability; P(B/A) is the probability of data B given that the hypothesis A was true; P (A) is the probability of hypothesis A being true regardless of data also known as prior probability of A; and P(B) is the probability of the data regardless of the hypothesis. A naïve Bayes algorithm may be generated by first transforming training data into a frequency table. Computing Device may then calculate a likelihood table by calculating probabilities of different data entries and classification labels. Computing device may utilize a naïve Bayes equation to calculate a posterior probability for each class. A class containing the highest posterior probability is the outcome of prediction.

Still referring to FIG. 2, although Naïve Bayes classifier may be primarily known as a probabilistic classification algorithm; however, it may also be considered a generative model described herein due to its capability of modeling the joint probability distribution P(X, Y) over observable variables X and target variable Y. In an embodiment, Naïve Bayes classifier may be configured to make an assumption that the features X are conditionally independent given class label Y, allowing generative model to estimate the joint distribution as P(X, Y)=P(Y)ΠiP(Xi|Y), wherein P(Y) may be the prior probability of the class, and P(Xᵢ|Y) is the conditional probability of each feature given the class. One or more generative machine learning models 160 containing Naïve Bayes classifiers may be trained on labeled training data, estimating conditional probabilities P(Xᵢ|Y) and prior probabilities P(Y) for each class; for instance, and without limitation, using techniques such as Maximum Likelihood Estimation (MLE). One or more generative machine learning models 160 containing Naïve Bayes classifiers may select a class label y according to prior distribution P(Y), and for each feature Xi, sample at least a value according to conditional distribution P(Xᵢ|y). Sampled feature values may then be combined to form one or more new data instance with selected class label y. In a non-limiting example, one or more generative machine learning models 160 may include one or more Naïve Bayes classifiers to generate new examples of features corresponding to missing features 136 based on classification of input data to feature templates 140 or the like, wherein the models may be trained using training data containing a plurality of features e.g., exemplary datasets 148, and/or the like as input correlated to a plurality of labeled classes e.g., cluster labels and/or feature templates 140 as output.

Still referring to FIG. 1, in some cases, one or more generative machine learning models 160 may include generative adversarial network (GAN). As used in this disclosure, a “generative adversarial network” is a type of artificial neural network with at least two sub models (e.g., neural networks), a generator, and a discriminator, that compete against each other in a process that ultimately results in the generator learning to generate new data samples, wherein the “generator” is a component of the GAN that learns to create hypothetical data by incorporating feedbacks from the “discriminator” configured to distinguish real data from the hypothetical data. In some cases, generator may learn to make discriminator classify its output as real. In an embodiment, discriminator may include a supervised machine learning model while generator may include an unsupervised machine learning model as described in further detail elsewhere in this disclosure.

With continued reference to FIG. 1, in an embodiment, discriminator may include one or more discriminative models, i.e., models of conditional probability P(Y|X=x) of target variable Y, given observed variable X. In an embodiment, discriminative models may learn boundaries between classes or labels in given training data. In a non-limiting example, discriminator may include one or more classifiers as described in further detail below with reference to FIG. 2 to distinguish between different categories e.g., correct versus incorrect entries for a feature, or states e.g., TRUE vs. FALSE within the context of generated data such as, without limitations, features, and/or the like. In some cases, computing device may implement one or more classification algorithms such as, without limitation, Support Vector Machines (SVM), Logistic Regression, Decision Trees, and/or the like to define decision boundaries.

In a non-limiting example, and still referring to FIG. 1, generator of GAN may be responsible for creating synthetic data that resembles real features. In some cases, GAN may be configured to receive datasets such as, without limitation, exemplary datasets 148 and/or secondary dataset, as input and generates corresponding features and/or new versions of secondary dataset and/or information describing or evaluating the performance of one or more features according to correctness of results as compared to exemplary datasets 148. On the other hand, discriminator of GAN may evaluate the authenticity of the generated content by comparing it to real exemplary datasets 148, for example, discriminator may distinguish between genuine and generated content and providing feedback to generator to improve the model performance.

With continued reference to FIG. 1, in other embodiments, one or more generative models may also include a variational autoencoder (VAE). As used in this disclosure, a “variational autoencoder” is an autoencoder (i.e., an artificial neural network architecture) whose encoding distribution is regularized during the model training process in order to ensure that its latent space includes desired properties allowing new data sample generation. In an embodiment, VAE may include a prior and noise distribution respectively, trained using expectation-maximization meta-algorithms such as, without limitation, probabilistic PCA, sparse coding, among others. In a non-limiting example, VEA may use a neural network as an amortized approach to jointly optimize across input data and output a plurality of parameters for corresponding variational distribution as it maps from a known input space to a low-dimensional latent space. Additionally, or alternatively, VAE may include a second neural network, for example, and without limitation, a decoder, wherein the “decoder” is configured to map from the latent space to the input space.

In a non-limiting example, and still referring to FIG. 1, VAE may be used by computing device, processor 104, and/or apparatus 100 to model complex relationships between second dataset 132 and exemplary datasets 148. In some cases, VAE may encode input data into a latent space, capturing examples of feature data. Such encoding process may include learning one or more probabilistic mappings from observed exemplary datasets 148 to a lower-dimensional latent representation. Latent representation may then be decoded back into the original data space, therefore reconstructing the missing features 136. In some cases, such decoding process may allow VAE to generate new examples or variations that are consistent with the learned distributions.

Still referring to FIG. 1, computing device may configure generative machine learning models 160 to analyze input data such as, without limitation, exemplary datasets 148 to one or more predefined templates such as feature representing correct second dataset 132 and/or features thereof as described above, thereby allowing computing device, processor 104, and/or apparatus 100 to identify discrepancies or deviations from desired or correct values for features. In some cases, computing device, processor 104, and/or apparatus 100 may be configured to pinpoint specific errors in features or any other aspects of the second dataset 132, in any iteration. In a non-limiting example, computing device, processor 104, and/or apparatus 100 may be configured to implement generative machine learning models 160 to incorporate additional models to detect new features and/or values to be used as new features. In some cases, errors may be classified into different categories or severity levels. In a non-limiting example, some errors may be considered minor, and generative machine learning model 160 such as, without limitation, GAN may be configured to generate features contain only slight adjustments while others may be more significant and demand more substantial corrections. In some embodiments, computing device, processor 104, and/or apparatus 100 may be configured to flag or highlight erroneous or incorrect features, altering the data directly on the second dataset 132 using one or more generative machine learning models 160 described herein. In some cases, one or more generative machine learning models 160 may be configured to generate and output indicators such as, without limitation, visual indicator, audio indicator, and/or any other indicators as described above. Such indicators may be used to signal the detected error described herein.

Still referring to FIG. 1, in some cases, computing device may be configured to identify and rank detected common deficiencies across plurality of secondary datasets; for instance, and without limitation, one or more machine learning models may classify errors in a specific order e.g., in a descending order of commonality. Such ranking process may enable a prioritization of most prevalent issues, allowing instructors or computing device, processor 104, and/or apparatus 100 to address such issues and/or deficiencies.

Still referring to FIG. 1, in some cases, one or more generative machine learning models 160 may also be applied by computing device, processor 104, and/or apparatus 100 to edit, modify, or otherwise manipulate existing data or data structures. In an embodiment, output of training data used to train one or more generative machine learning models 160 such as GAN as described herein may include exemplary datasets 148 that linguistically or visually demonstrate modified datasets having missing features 136 e.g., by generating the missing features 136, or the like. In some cases, exemplary secondary data and/or features may be synchronized with exemplary datasets 148.

Additionally, or alternatively, and still referring to FIG. 1, computing device, processor 104, and/or apparatus 100 may be configured to continuously monitor exemplary datasets 148. In an embodiment, computing device, processor 104, and/or apparatus 100 may configure discriminator to provide ongoing feedback and further corrections as needed to subsequent input data (e.g., data to be used as a further second dataset 132). An iterative feedback loop may be created as computing device, processor 104, and/or apparatus 100 continuously receive real-time data, identify errors as a function of real-time data, delivering corrections based on the identified errors, and monitoring user feedback and/or error functions on the delivered corrections. In an embodiment, computing device, processor 104, and/or apparatus 100 may be configured to retrain one or more generative machine learning models 160 based on update exemplary datasets 148 or update training data of one or more generative machine learning models 160 by integrating updated exemplary datasets 148 into the original training data. In such embodiment, iterative feedback loop may allow machine learning module to adapt to the feedback and/or updated datasets, enabling one or more generative machine learning models 160 described herein to learn and update based on exemplary outputs and generated feedback.

With continued reference to FIG. 1, other exemplary embodiments of generative machine learning models 160 may include, without limitation, long short-term memory networks (LSTMs), (generative pre-trained) transformer (GPT) models, mixture density networks (MDN), and/or the like. As an ordinary person skilled in the art, upon reviewing the entirety of this disclosure, will be aware of various generative machine learning models 160 may be used to generate missing features 136.

Still referring to FIG. 1, in a further non-limiting embodiment, machine learning module may be further configured to generate a multi-model neural network that combines various neural network architectures described herein. In a non-limiting example, multi-model neural network may combine LSTM for time-series analysis with GPT models for natural language processing. Such fusion may be applied by computing device to generate data to be used for missing features 136. In some cases, multi-model neural network may also include a hierarchical multi-model neural network, wherein the hierarchical multi-model neural network may involve a plurality of layers of integration; for instance, and without limitation, different models may be combined at various stages of the network. Convolutional neural network (CNN) may be used for image feature extraction, followed by LSTMs for sequential pattern recognition, and a MDN at the end for probabilistic modeling. Other exemplary embodiments of multi-model neural network may include, without limitation, ensemble-based multi-model neural network, cross-modal fusion, adaptive multi-model network, among others. As an ordinary person skilled in the art, upon reviewing the entirety of this disclosure, will be aware of various generative machine learning models 160 may be used to generate missing features 136 described herein. As an ordinary person skilled in the art, upon reviewing the entirety of this disclosure, will be aware of various multi-model neural network and combination thereof that may be implemented by apparatus 100 in consistent with this disclosure.

Continuing to refer to FIG. 1, processor 104 and/or apparatus 100 is configured to perform a comparative process 164 using the first dataset 112 and the interpolated second dataset 132. A “comparative process 164,” as used in this disclosure, is a process that compares first dataset 112 and second dataset 132. For instance, where first dataset 112 represents a project to be completed, such as a paving, construction, or similar project, and second dataset 132 represents data concerning that project, a comparative process 164 may be a process that determines the extent to which the project represented by second dataset 132 has been completed according to first dataset 112. In some embodiments, comparative process 164 may include a machine-learning process.

Still referring to FIG. 1, and as a non-limiting example of a comparative process 164, processor 104 may be configured to generate a performance analysis based on a comparison of the received second dataset 132 to the received first dataset 112. As used herein, a “performance analysis” consists of a comparison of the executed actions, resource allocations, and expenditures as compared to projected estimates, wherein projected estimates may be based on a combination of user approximations, comparable historical engagements, and machine-learning processes. A benchmark valuation module 140 may identify the needs and efforts built within first dataset 112 and generate a projected schedule. This schedule projection may be similar to that described within the [1531-001USU1] application referenced above.

Still referring to FIG. 1, benchmark valuation 140 may use machine-learning processes to assess a rating of each category of data as compared to historical data, publicly available information sources, and direct user input. The categories of data may rely on the categorization applied by data synthesis 136 and discussed above. Machine-learning processes may rely on training data, such as prior engagements, to project staffing, equipment and timelines. In a continued non-limiting embodiment of a parking lot construction, historical data may reveal that every project requires a supervisor, then an additional worker is required for every one hundred square feet of asphalt and each 300 linear feet of curb installation in order to complete the job at a moderate pace. Similarly, a minimum equipment allocation may be estimated based on the project overview as described within first dataset 112. Each projection aspect may be augmented by human input in cases where extenuating circumstances mandate it for an accurate estimate. As the project is executed, updates within first dataset 112 may be used to track progress as compared to estimates. In a non-limiting embodiment, a project showing a two week delay may be rated poorly and generate a prompt for a proposed corrective action, such as requesting and ordering materials with one week of additional foresight. In a separate non-limiting embodiment, the driveway image may reveal that the initial concrete pour of the driveway was completed in a non-compliant manner causing the driveway to appear to be in decent condition, but actually limiting the lifespan of the driveway to ten years less than that of a compliantly poured concrete driveway. These types of image-based assessments may be conducted by an image classifier 128.

Still referring to FIG. 1, processor 104 may be configured to estimate the effects of inaction as compared to varying degrees of alternative options. Each identified candidate model may include an exemplary set of steps for a standard maintenance plan. Each candidate model may further include scalable changes to the maintenance plan with proportionate changes in cost, timing, and/or quality. In a non-limiting embodiment, a maintenance program for an aging wood window frame may include a one-time sanding, filling, and repainting to restore the window to full operational status. This candidate model may additionally allow a user to select a cost above or below the model maintenance program which would improve or decrease quality, respectively. User may need the maintenance done immediately to seal up a hole that rainwater leaks into every time it rains, in which case, the user's selection of a shortest time as a prioritization method would modify the candidate model to simply patch the hole and prevent further rain damage. Additionally, in a separate non-limiting embodiment, user may select lowest cost, wherein the candidate model may present the estimated deterioration and affiliated cost of taking no remedial action, as well as a quick patch fix which would not be expected to last through the summer but would be the least cost other than doing nothing. Processor 104 may additionally calculate the cost of a full window replacement, which would be the only available option in one year if the user selects to take no action now. All of these modifiable selections may be displayed in GUI 120 and allow the user to actively manipulate each of the priorities to select the best fit maintenance program.

Still referring to FIG. 1, processor 104 may be configured to apply proprietary methods to estimate the cost of inaction as compared to varying degrees of alternate material order options. In a non-limiting embodiment, where benchmark valuation 140 identifies a projected or realized delay, it may propose a set of corrective actions wherein one of the options projects out the effects of taking no corrective action. The alternate options may capture the projected reduced costs and/or delays based on varying degrees of applicable corrective actions. For example, while adding may reduce the projected timeline by three weeks, it would also increase expenditures by twenty percent. Benchmark valuation 140 may display these types of alternatives for user through remote device 124 and/or GUI 120. This display may be restricted to a primary option, with a more and a less aggressive alternative. These options may be based on a prioritization method, as discussed within [1531-001USU1] application. The specific methods of prioritization and cost estimation, resource properties and estimations may all rely on proprietary methods.

Still referring to FIG. 1, benchmark valuation 140 may continuously import data from the affiliated models such as accounting, material ordering applications, manpower, and any other applicable model. In a non-limiting embodiment, benchmark valuation 140 may compare the hours logged by personnel assigned to the job with the work getting done to identify a type of work velocity. As used herein, a “work velocity” refers to the amount of work an individual or a team accomplished over a standard amount of time. Benchmark valuation 140 may implement an organizational average work velocity and compare the current engagement's progress to assess if the work is progressing as expected, falling behind, or is ahead of schedule. Similarly an equipment velocity may be enforced for each piece of allocated equipment in order to optimize the allocation of where the equipment may be most effectively engaged.

Still referring to FIG. 1, processor 104 may be configured to identify at least a mitigating remediation for each determined gap. As used herein, a “mitigating remediation” refers to the set of resources or actions that will be necessary to continue or conclude the engagement summarized within first dataset 112. User may dictate the timeline within which upcoming material demands applies, or rely on training data from historical engagements. All current and future material allocations and tasks may be analyzed by a provisions analysis module 144. In a non-limiting embodiment, where a first dataset 112 reveals that ten thousand cubic feet of asphalt will be needed on a specified date, user may assess that asphalt should be ordered two weeks in advance, or user may direct processor 104 that all orders shall be placed one month in advance of projected use, or a machine-learning process may identify the historical lead time of orders and assign an order date with a ten percent buffer or comparable method. Processor 104 may be configured to use machine-learning processes to associate first dataset 112 with a set of affiliated material demands based on historical data, publicly available information sources, or direct user input. Each method for assessing order timeline and needs may still enable the automated generation of work orders where a set of equipment or expendable material is projected. Once generated, user may authorize the work order. User may also modify the work order or cancel it altogether. All decisions may be tracked by processor 104 and stored within memory 108 for future application in the current or subsequent engagements as training data.

Still referring to FIG. 1, processor 104 may be configured to verify imported images or other portions of first dataset 112 prior to processing the images. This verification may rely on the metadata appended to the images, including location, timing, and image source. Once verified by validating the appropriate time separation, same location, same source, or some combination of these as accepted by the user, the image is classified and processed as described above. If any of the metadata indicates a potential discrepancy, processor 104 may prompt the user to make a decision about the validity of the image prior to processing the image.

Still referring to FIG. 1, processor 104 and/or apparatus 100 is configured to configure a remote device 124 to display a result of the comparative process 164. This may include, without limitation, display of a generated performance analysis to a user. As discussed above, this display may rely on remote device 124 and/or GUI 120 and may involve any configuration thereof using any process and/or components described above. User may provide feedback on the data displayed or layout within which it is displayed. Processor 104 may enable machine-learning processes to dynamically modify GUI 120 based on training data and user inputs.

Referring now to FIG. 2, an exemplary embodiment of a machine-learning module 200 that may perform one or more machine-learning processes as described in this disclosure is illustrated. Machine-learning module 200 may perform determinations, classification, and/or analysis steps, methods, processes, or the like as described in this disclosure using machine-learning processes. A “machine-learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine-learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure. As a non-limiting illustrative example a set of first dataset 112 characteristics may be used as inputs wherein training data from historical engagements supports affiliating some, all, or none of the first dataset 112 attributes with certain classifier descriptors. In a specific non-limiting embodiment, a first dataset 112 may include an asphalt driveway project, which may apply a classifier descriptor of “asphalt” and “driveway” based not only on those words appearing, but on historical engagements showing that those descriptors are productive and accurate.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine-learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to a certain type of project or engagement, wherein the sub-population of certain projects or engagements require a unique set of personnel, material, and equipment that distinguishes them from the multitude of engagement types.

Still referring to FIG. 2, computing device 104 may be configured to generate a classifier using a Naïve Bayes classification algorithm as described above. Alternatively or additionally, training classifier may include a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 2, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm:

$$l = \sqrt{{\sum }_{i = 0}^{n} {{a}_{i}}^{2}} ,$$

where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. Computing device, processor, and/or module may automatically generate a missing training example; this may be done by receiving or retrieving a missing input and/or output value and correlating the missing input and/or output value with a corresponding output and/or input value collocated in a data record with the retrieved value, provided by a user and/or other device, or the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value.

As a non-limiting example, and with further reference to FIG. 2, images used to train an image classifier 128 or other machine-learning model and/or process that takes images as inputs or generates images as outputs may be rejected if image quality is below a threshold value. For instance, and without limitation, computing device, processor, and/or module may perform blur detection, and eliminate one or more blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine-learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by up-sampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs down-sampled to smaller numbers of units, and a neural network or other machine-learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier 128, a machine-learning model may have a set of interpolation rules trained by sets of highly detailed images and images that have been down-sampled to smaller numbers of pixels, and a neural network or other machine-learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform down-sampling on data. Down-sampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine-learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include labeled seed data, as described above as inputs, vector clustering, as described above as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine-learning processes may include at least an unsupervised machine-learning processes 232. An unsupervised machine-learning process, as used herein, is a process that derives inferences in data sets without regard to labels; as a result, an unsupervised machine-learning process may be free to discover any structure, relationship, and/or correlation provided in the data. Unsupervised processes 232 may not require a response variable; unsupervised processes 232 may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above. Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

Referring to FIG. 3, a chatbot 116 system 300 is schematically illustrated. According to some embodiments, a user interface 304 may be communicative with a computing device 308 that is configured to operate a chatbot 116. In some cases, user interface 304 may be local to computing device 308. Alternatively or additionally, in some cases, user interface 304 may remote to computing device 308 and communicative with the computing device 308, by way of one or more networks, such as without limitation the internet. Alternatively or additionally, user interface 304 may communicate with user device 308 using telephonic devices and networks, such as without limitation fax machines, short message service (SMS), or multimedia message service (MMS). Commonly, user interface 304 communicates with computing device 308 using text-based communication, for example without limitation using a character encoding protocol, such as American Standard for Information Interchange (ASCII). Typically, a user interface 304 conversationally interfaces a chatbot 116, by way of at least a submission 312, from the user interface 308 to the chatbot 116, and a response 316, from the chatbot 116 to the user interface 304. In many cases, one or both of submission 312 and response 316 are text-based communication. Alternatively or additionally, in some cases, one or both of submission 312 and response 316 are audio-based communication.

Continuing in reference to FIG. 3, a submission 312 once received by computing device 308 operating a chatbot 116, may be processed by a processor. In some embodiments, processor processes a submission 312 using one or more of keyword recognition, pattern matching, and natural language processing. In some embodiments, processor employs real-time learning with evolutionary algorithms. In some cases, processor may retrieve a pre-prepared response from at least a storage component 320, based upon submission 312. Alternatively or additionally, in some embodiments, processor communicates a response 316 without first receiving a submission 312, thereby initiating conversation. In some cases, processor communicates an inquiry to user interface 304; and the processor is configured to process an answer to the inquiry in a following submission 312 from the user interface 304. In some cases, an answer to an inquiry present within a submission 312 from a user device 304 may be used by computing device 308 as an input to another function.

With continued reference to FIG. 3, chatbot 116 may be configured to provide a user with a plurality of options as an input into the chatbot 116. Chatbot 116 entries may include multiple choice, short answer response, true or false responses, and the like. A user may decide on what type of chatbot 116 entries are appropriate. In some embodiments, the chatbot 116 may be configured to allow the user to input a freeform response into the chatbot 116. Chatbot 116 may then use a decision tree, data base, or other data structure to respond to the user's entry into the chatbot 116 as a function of a chatbot 116 input. As used in the current disclosure, “Chatbot 116 input” is any response that an entity or user inputs into a chatbot 116 as a response to a prompt or question.

With continuing reference to FIG. 3, computing device 308 may be configured to respond to a chatbot 116 input using a decision tree. A “decision tree,” as used in this disclosure, is a data structure that represents and combines one or more determinations or other computations based on and/or concerning data provided thereto, as well as earlier such determinations or calculations, as nodes of a tree data structure where inputs of some nodes are connected to outputs of others. Decision tree may have at least a root node, or node that receives data input to the decision tree, corresponding to at least a candidate input into a chatbot 116. Decision tree has at least a terminal node, which may alternatively or additionally be referred to herein as a “leaf node,” corresponding to at least an exit indication; in other words, decision and/or determinations produced by decision tree may be output at the at least a terminal node. Decision tree may include one or more internal nodes, defined as nodes connecting outputs of root nodes to inputs of terminal nodes. Computing device 308 may generate two or more decision trees, which may overlap; for instance, a root node of one tree may connect to and/or receive output from one or more terminal nodes of another tree, intermediate nodes of one tree may be shared with another tree, or the like.

Still referring to FIG. 3, computing device 308 may build decision tree by following relational identification; for example, relational indication may specify that a first rule module receives an input from at least a second rule module and generates an output to at least a third rule module, and so forth, which may indicate to computing device 308 an in which such rule modules will be placed in decision tree. Building decision tree may include recursively performing mapping of execution results output by one tree and/or subtree to root nodes of another tree and/or subtree, for instance by using such execution results as execution parameters of a subtree. In this manner, computing device 308 may generate connections and/or combinations of one or more trees to one another to define overlaps and/or combinations into larger trees and/or combinations thereof. Such connections and/or combinations may be displayed by visual interface to user, for instance in first view, to enable viewing, editing, selection, and/or deletion by user; connections and/or combinations generated thereby may be highlighted, for instance using a different color, a label, and/or other form of emphasis aiding in identification by a user. In some embodiments, subtrees, previously constructed trees, and/or entire data structures may be represented and/or converted to rule modules, with graphical models representing them, and which may then be used in further iterations or steps of generation of decision tree and/or data structure. Alternatively or additionally, subtrees, previously constructed trees, and/or entire data structures may be converted to APIs to interface with further iterations or steps of methods as described in this disclosure. As a further example, such subtrees, previously constructed trees, and/or entire data structures may become remote resources to which further iterations or steps of data structures and/or decision trees may transmit data and from which further iterations or steps of generation of data structure receive data, for instance as part of a decision in a given decision tree node.

Continuing to refer to FIG. 3, decision tree may incorporate one or more manually entered or otherwise provided decision criteria. Decision tree may incorporate one or more decision criteria using an API. Decision tree may establish a link to a remote decision module, device, system, or the like. Decision tree may perform one or more database lookups and/or look-up table lookups. Decision tree may include at least a decision calculation module, which may be imported via an API, by incorporation of a program module in source code, executable, or other form, and/or linked to a given node by establishing a communication interface with one or more exterior processes, programs, systems, remote devices 124, or the like; for instance, where a user operating system has a previously existent calculation and/or decision engine configured to make a decision corresponding to a given node, for instance and without limitation using one or more elements of domain knowledge, by receiving an input and producing an output representing a decision, a node may be configured to provide data to the input and receive the output representing the decision, based upon which the node may perform its decision. In a non-limiting embodiment, based on a limited set of first dataset 112 data provided for input, decision tree may generate a plurality of follow-up questions, each based on the aggregated sum of data available from all inputs. Specifically, an first dataset 112 containing only a picture of a deteriorating driveway may generate a branch of questions focused on a variety of potential driveway repairs, wherein a positive assertion to a question about concrete may further trigger questions to assess local physical conditions such as temperature, winter severity, expected pressures, etc., then eventually narrow in to explicitly isolate the engagement type to a defined candidate set, such as a four inch concrete slap installation. Continuing with the concrete driveway example, a follow up question may query about timeline availability, wherein a response of “as soon as possible” would potentially trigger a query of available dates and restrictions based on the installation. These decision tree questions may be used to bridge the gap of first dataset 112 data to available candidate sets. So immediately once chatbot 300 is able to isolate subject data to an available candidate set, questioning may conclude. User feedback to affirm or reject the identified candidate set would be used as training data for future chatbot 116 interrogations and candidate set affiliations as described above.

Referring now to FIG. 4, an exemplary embodiment of neural network 400 is illustrated. A neural network 400 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 404, one or more intermediate layers 408, and an output layer of nodes 412. In a non-limiting embodiment, input layer of nodes 404 may include any remote display where user inputs may be provided from, while output layer of nodes 412 may include either the local device if it has the processing capability to support the requisite machine-learning processes, or output layer of nodes 412 may refer to a centralized, network connected processor able to remotely conduct the machine-learning processes described herein. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. Connections may run solely from input nodes toward output nodes in a “feed-forward” network or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

Referring now to FIG. 5, an exemplary embodiment of a node 500 of a neural network is illustrated. A node may include, without limitation, a plurality of inputs x, that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tanh (hyperbolic tangent) function, of the form

$$\frac{{e}^{x} - {e}^{- x}}{{e}^{x} + {e}^{- x}} ,$$

a tanh derivative function such as ƒ(x)=tanh²(x), a rectified linear unit function such as ƒ(x)=max(0, x), a “leaky” and/or “parametric” rectified linear unit function such as ƒ(x)=max(ax, x) for some a, an exponential linear units function such as

$$f ( x ) = \{ \begin{matrix}x & for x \geq 0 \\ α ( {e}^{x} - 1 ) & for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as ƒ(x)=x*sigmoid(x), a Gaussian error linear unit function such as

$$f ( x ) = a ( 1 + tanh ( \sqrt{2 / π} ( x + {bx}^{r} ) ) )$$

for some values of a, b, and r, and/or a scaled exponential linear unit function such as

$$f ( x ) = λ \{ \begin{matrix}α ( {e}^{x} - 1 ) & for x < 0 \\ x & for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ may be determined by training a neural network using training data, which may be performed using any suitable process as described above.

Referring now to FIG. 6, an exemplary embodiment of fuzzy set comparison 600 is illustrated. In a non-limiting embodiment, fuzzy sets may be used to analyze and correlate unlabeled data with prior identified cohort classification mechanisms. A first fuzzy set 604 may be represented, without limitation, according to a first membership function 608 representing a probability that an input falling on a first range of values 612 is a member of the first fuzzy set 604, where first membership function 608 has values on a range of probabilities such as without limitation the interval [0,1], and an area beneath first membership function 608 may represent a set of values within first fuzzy set 604. Although first range of values 612 is illustrated for clarity in this exemplary depiction as a range on a single number line or axis, first range of values 612 may be defined on two or more dimensions, representing, for instance, a Cartesian product between a plurality of ranges, curves, axes, spaces, dimensions, or the like. First membership function 608 may include any suitable function mapping first range 612 to a probability interval, including without limitation a triangular function defined by two linear elements such as line segments or planes that intersect at or below the top of the probability interval. As a non-limiting example, triangular membership function may be defined as:

$$y ( x , a , b , c ) = \{ \begin{matrix}0 , & for x > c and x < a \\ \frac{x - a}{b - a} , & for a \leq x < b \\ \frac{c - x}{c - b} , & if b < x \leq c\end{matrix}$$

a trapezoidal membership function may be defined as:

$$y ( x , a , b , c , d ) = max ( min ( \frac{x - a}{b - a} , 1 , \frac{d - x}{d - c} ) , 0 )$$

a sigmoidal function may be defined as:

$$y ( x , a , c ) = \frac{1}{1 - {e}^{- a ( x - c )}}$$

a Gaussian membership function may be defined as:

$$y ( x , c , σ ) = {e}^{- \frac{1}{2} {( \frac{x - c}{σ} )}^{2}}$$

and a bell membership function may be defined as:

$$y ( x , a , b , c , ) = {[ 1 + {\vert \frac{x - c}{a} \vert}^{2 b} ]}^{- 1}$$

Persons skilled in the art, upon reviewing the entirety of this disclosure, will be aware of various alternative or additional membership functions that may be used consistently with this disclosure.

Still referring to FIG. 6, first fuzzy set 604 may represent any value or combination of values as described above, including output from one or more machine-learning models, a predetermined class, such as without limitation, engagement details associated with a sidewalk installation in a given locality. In a non-limiting embodiment, these details may include formed “concrete pouring” and “concrete roughening.” A second fuzzy set 616, which may represent any value which may be represented by first fuzzy set 604, may be defined by a second membership function 620 on a second range 624; second range 624 may be identical and/or overlap with first range 612 and/or may be combined with first range 612 via Cartesian product or the like to generate a mapping permitting evaluation overlap of first fuzzy set 604 and second fuzzy set 616. Continuing the non-limiting embodiment where first fuzzy set 604 may be a sidewalk installation containing certain descriptors, second fuzzy set 616 may be an individual classifier descriptor, such as “concrete friction application”. Each piece of data, after being converted to a vector representation, may then be compared. Where first fuzzy set 604 and second fuzzy set 616 have a region 628 that overlaps, first membership function 608 and second membership function 620 may intersect at a point 632 representing a probability, as defined on probability interval, of a match between first fuzzy set 604 and second fuzzy set 616. Alternatively or additionally, a single value of first and/or second fuzzy set may be located at a locus 636 on first range 612 and/or second range 624, where a probability of membership may be taken by evaluation of first membership function 608 and/or second membership function 620 at that range point. A probability at 628 and/or 632 may be compared to a threshold 640 to determine whether a positive match is indicated. Threshold 640 may, in a non-limiting example, represent a degree of match between first fuzzy set 604 and second fuzzy set 616, and/or single values therein with each other or with either set, which is sufficient for purposes of the matching process; for instance, threshold may indicate a sufficient degree of overlap between “concrete roughening” and “concrete friction application” for combination to occur as described above, thereby indicating a strong likelihood of the patient having a brain tumor condition. Alternatively or additionally, each threshold may be tuned by a machine-learning process.

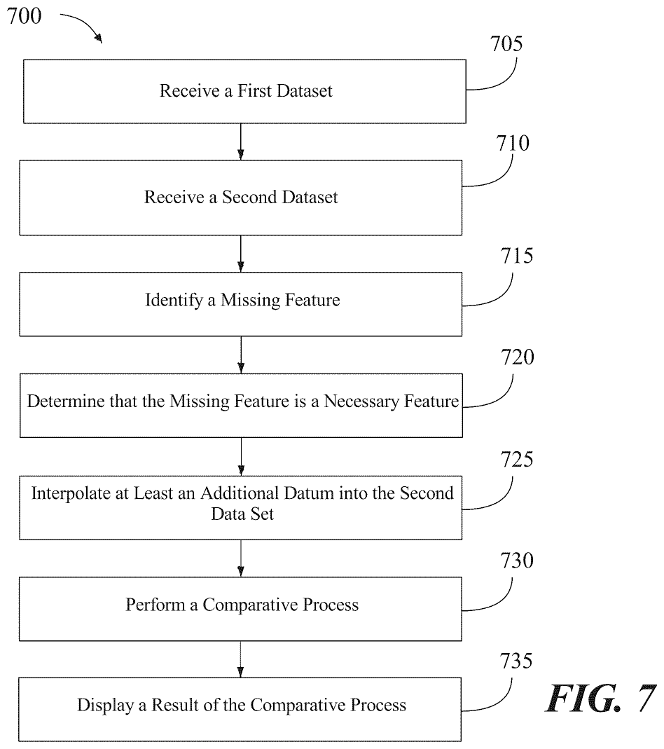

Referring now to FIG. 7, a flow diagram of an exemplary method 700 for integrated optimization-guided interpolation is illustrated. At step 705, method 700 includes receiving a first dataset 112 having a known degree of completion at a processor. This may be implemented as described and with reference to FIGS. 1-6.

Still referring to FIG. 7, at step 710, processor receives a second dataset 132 having an unknown degree of completion. This may be implemented as described and with reference to FIGS. 1-6.

With further reference to FIG. 7, at step 715, processor identifies at least a missing feature 136 in the second data set. This may be implemented as described and with reference to FIGS. 1-6.

Continuing to refer to FIG. 7, at step 720, processor determines that at least a missing feature 136 is a necessary feature, wherein determining further comprises determining that the at least a missing feature 136 is a necessary feature according to at least an optimization criterion. This may be implemented as described and with reference to FIGS. 1-6.

Still referring to FIG. 7, at step 725, processor interpolates at least an additional datum into the second data set, wherein the at least an additional datum is a substitute for the missing feature 136. This may be implemented as described and with reference to FIGS. 1-6.

At step 730, and with continued reference to FIG. 7, processor performs a comparative process 164 using the first dataset 112 and the interpolated second dataset 132. This may be implemented as described and with reference to FIGS. 1-6.

Still referring to FIG. 7, at step 735 processor configures a remote device 124 to display a result of the comparative process 164. This may be implemented as described and with reference to FIGS. 1-6.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

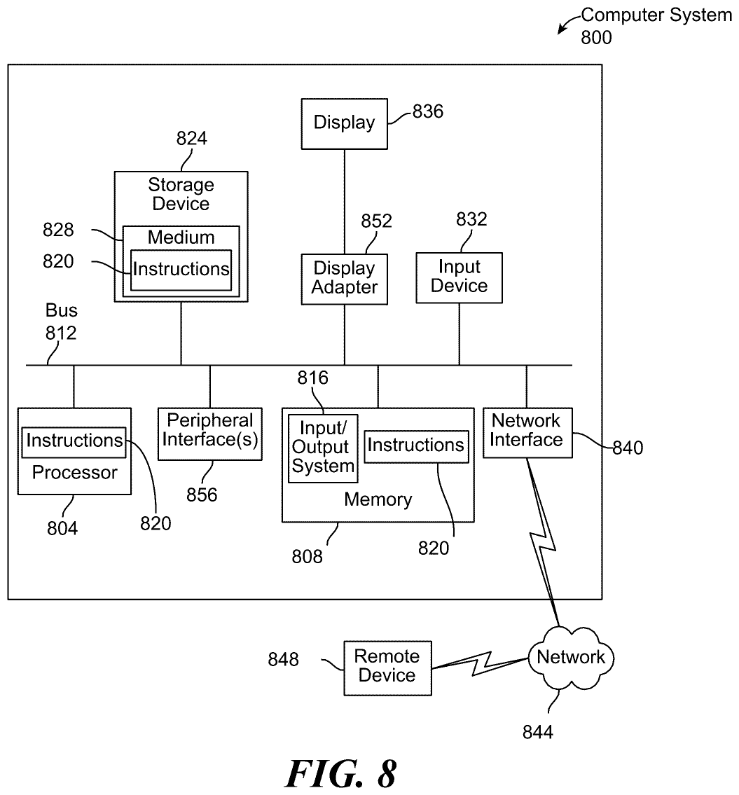

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC).

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a remote device, such as remote device 836. Examples of a remote device include, but are not limited to, a liquid crystal display (LCD), a cathode ray tube (CRT), a plasma display, a light emitting diode (LED) display, and any combinations thereof. Display adapter 852 and remote device 836 may be utilized in combination with processor 804 to provide graphical representations of aspects of the present disclosure. In addition to a remote device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve the methods according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

1. An apparatus for integrated optimization-guided interpolation in datasets, wherein the apparatus comprises:
at least a processor, and a memory communicatively configuring the at least a processor, the memory containing instructions configuring the at least a processor to:
generate a first dataset, wherein generating the first dataset comprises:
identifying a type of project;
selecting a representative stored candidate model as a function of the identified type of project;
comparing at least two user inputs to the representative stored candidate model; and
determining a required piece of information as a function of the comparison between the at least two user inputs and the representative stored candidate model;
receive a second dataset having an unknown degree of completion;
identify at least a missing feature in the second data set;
determine that at least a missing feature is a necessary feature by generating an importance metric using the at least a missing feature and comparing the importance metric to a threshold criterion, wherein generating the importance metric comprises:
iteratively training an importance metric machine learning model using training data applied to an input layer of nodes comprising an identification of a feature input, one or more intermediate layers, and an output layer of nodes comprising an importance metric parameter output;
adjusting one or more connections and one or more weights between nodes in adjacent layers of the importance metric machine learning model to iteratively update the one or more weights between nodes by updating the training data applied to the input layer of nodes;
interpolate at least an additional datum into the second data set, wherein the at least an additional datum is a substitute for the missing feature, wherein the at least an additional datum is generated as a function of the necessary feature;
perform a comparative process using the first dataset and the interpolated second dataset, wherein the first dataset represents a project to be completed, wherein the second dataset represents data concerning the project, wherein the comparative process determines an extent to which the project represented by the second dataset has been completed according to the first dataset, wherein the comparative process comprises:
generating a performance analysis based on a comparison of the first dataset to the second dataset, wherein the performance analysis is a comparison of executed actions compared to project estimates;
generate a projected schedule as a function of the performance analysis and comparative analysis;
update the first dataset to track progress of the project as compared to the projected schedule;
generate a prompt for a proposed corrective action, wherein the proposed corrected action is prompted if the progress of the project is delayed; and
configure a remote device to display a result of the comparative process and performance analysis.

2. The apparatus of claim 1, wherein receiving the second dataset comprises:
receiving at least an image; and
generating the second dataset using the at least an image and an image classifier.

3. The apparatus of claim 1, wherein receiving the second dataset comprises:
receiving at least an image; and
generating the second dataset using the at least an image and an optical character recognition process.

4. The apparatus of claim 1, wherein identifying at least a missing feature further comprises:
classifying the second dataset to a feature template using a template classifier;
comparing the second dataset to the feature template; and
identifying at least a missing feature based on the comparison.

5. The apparatus of claim 1, wherein identifying at least a missing feature further comprises:
receiving at least an exemplary dataset;
training a feature identification machine-learning model as a function of the at least an exemplary dataset; and
identifying the at least a missing feature using the feature identification machine-learning model and the second dataset.

6. (canceled)

7. The apparatus of claim 1, wherein generating the importance metric further comprises:
receiving a plurality of training examples, wherein each training example correlates an identification of a feature with an importance metric parameter;
training an importance metric machine-learning model as a function of the plurality of training examples; and
generating the importance metric using the identification of the at least a missing feature and the importance metric machine-learning model.

8. The apparatus of claim 1, wherein interpolating at least an additional datum further comprises:
receiving at least an exemplary dataset; and
interpolating at least an additional datum as a function of the at least an exemplary dataset.

9. The apparatus of claim 5, wherein interpolating at least an additional datum further comprises:
training a generative machine-learning model using the at least an exemplary dataset and a generative machine-learning algorithm; and
interpolating at least an additional datum using the generative machine-learning model.

10. The apparatus of claim 1, wherein the comparative process further comprises a machine-learning process.

11. A method for integrated data synthetization, evaluation, and resource acquisition, wherein the method comprises:
generating, at a processor, a first dataset, wherein generating the first dataset comprises:
identifying a type of project;
selecting a representative stored candidate model as a function of the identified type of project;
comparing at least two user inputs to the representative stored candidate model; and
determining a required piece of information as a function of the comparison between the at least two user inputs and the representative stored candidate model;
receiving, at the processor, a second dataset having an unknown degree of completion;
identifying, by the processor, at least a missing feature in the second data set;
determining, by the processor, that at least a missing feature is a necessary feature by generating an importance metric using the at least a missing feature and comparing the importance metric to a threshold criterion, wherein generating the importance metric comprises:
iteratively training an importance metric machine learning model using training data applied to an input layer of nodes comprising an identification of a feature input, one or more intermediate layers, and an output layer of nodes comprising an importance metric parameter output;
adjusting one or more connections and one or more weights between nodes in adjacent layers of the importance metric machine learning model to iteratively update the one or more weights between nodes by updating the training data applied to the input layer of nodes;
interpolating, by the processor, at least an additional datum into the second data set, wherein the at least an additional datum is a substitute for the missing feature, wherein the at least an additional datum is generated as a function of the necessary feature;
performing, by the processor, a comparative process using the first dataset and the interpolated second dataset, wherein the first dataset represents a project to be completed, wherein the second dataset represents data concerning the project, wherein the comparative process determines an extent to which the project represented by the second dataset has been completed according to the first dataset, wherein the comparative process comprises:
generating a performance analysis based on a comparison of the first dataset to the second dataset, wherein the performance analysis is a comparison of executed actions compared to project estimates;
generating a projected schedule as a function of the performance analysis and comparative analysis;
updating the first dataset to track progress of the project as compared to the projected schedule;
generating a prompt for a proposed corrective action, wherein the proposed corrected action is prompted if the progress of the project is delayed; and
configuring, by the processor, a remote device to display a result of the comparative process and performance analysis.

12. The method of claim 11, wherein receiving the second dataset comprises:
receiving at least an image; and
generating the second dataset using the at least an image and an image classifier.

13. The method of claim 11, wherein receiving the second dataset comprises:
receiving at least an image; and
generating the second dataset using the at least an image and an optical character recognition process.

14. The method of claim 11, wherein identifying at least a missing feature further comprises:
classifying the second dataset to a feature template using a template classifier;
comparing the second dataset to the feature template; and
identifying at least a missing feature based on the comparison.

15. The method of claim 11, wherein identifying at least a missing feature further comprises:
receiving at least an exemplary dataset;
training a feature identification machine-learning model as a function of the at least an exemplary dataset; and
identifying the at least a missing feature using the feature identification machine-learning model and the second dataset.

16. (canceled)

17. The method of claim 11, wherein generating the importance metric further comprises:
receiving a plurality of training examples, wherein each training example correlates an identification of a feature with an importance metric parameter;
training an importance metric machine-learning model as a function of the plurality of training examples; and
generating the importance metric using the identification of the at least a missing feature and the importance metric machine-learning model.

18. The method of claim 11, wherein interpolating at least an additional datum further comprises:
receiving at least an exemplary dataset; and
interpolating at least an additional datum as a function of the at least an exemplary dataset.

19. The method of claim 15, wherein interpolating at least an additional datum further comprises:
training a generative machine-learning model using the at least an exemplary dataset and a generative machine-learning algorithm; and
interpolating at least an additional datum using the generative machine-learning model.

20. The method of claim 11, wherein the comparative process further comprises a machine-learning process.
